(19) United States
(12) Patent Application Publication
(10) Pub. No.: US 2008/0297497 A1
(43) Pub. Date: Dec. 4, 2008

(54) CONTROL CIRCUIT AND METHOD OF LIQUID CRYSTAL DISPLAY PANEL

(75) Inventors: Ling-Chih Lu, Hsinchu County (TW); Ching-Hsiang Hsu, Taipei City (TW)

Correspondence Address: J C PATENTS, INC., 4 VENTURE, SUITE 250, IRVINE, CA, 92618, US

(73) Assignee: FARADAY TECHNOLOGY CORP., Hsinchu (TW)

(21) Appl. No.: 11/756,878

(22) Filed: Jun. 1, 2007

(51) Int. Cl. G09G 5/00

(52) U.S. Cl. 345/208

(57) ABSTRACT

A control circuit of a liquid crystal display (LCD) panel and a method thereof are provided. The circuit includes a frame memory, a look-up table (LUT) module, and a signal processor. The frame memory provides a previous value of a pixel, and the previous value includes at least one bit of a previous frame data of the pixel. The LUT module provides a plurality of basic values according to the previous value and a current value of the pixel, and the current value includes at least one bit of a current frame data of the pixel. The signal processor produces a driving value according to the basic values and replaces the current frame data with the driving value.

### BACKGROUND OF THE INVENTION

1. Field of the Invention

The present invention relates to a control circuit of a liquid crystal display (LCD) panel and a method thereof. More particularly, the present invention relates to a control circuit of a LCD panel which increases the response speed of the LCD with an accelerating voltage and a method thereof.

2. Description of Related Art

Image retention may be caused while a liquid crystal display (LCD) displays dynamic images if the response speed of the LCD is too low. The response speed of the LCD can be increased by changing the driving waveform of the LCD with an accelerating voltage, accordingly the dynamic image quality can be improved. FIG. 1A and FIG. 1B are waveforms of a pixel driving voltage in a LCD. Referring to FIG. 1A, the brightness variation of a pixel of the LCD is as curve 103 when a typical driving voltage waveform 101 is provided to the pixel, which takes nearly 3 frame time S110 to reach the desired brightness. Next, referring to FIG. 1B, if an accelerating voltage waveform 102 is provided to the same pixel, since the driving voltage is higher, the brightness variation of the pixel is as curve 104, which takes only 1 frame time S120 to reach the desired brightness. Accordingly, the response speed of the LCD can be increased by providing a higher accelerating voltage.

FIG. 2 is a schematic block diagram illustrating the response speed of a LCD being increased by an accelerating voltage in a conventional LCD. Referring to FIG. 2, the frame memory 202 is a dynamic random access memory used for storing a previous frame data Gₙ₋₁. An accelerating voltage value is obtained by looking up a look up table 203 (LUT) stored in the memory according to the previous frame data Gₙ₋₁ and a current frame data Gₙ. Usually the memory for storing the LUT is a static random access memory (SRAM) in order to quicken up the speed of looking up the accelerating voltage. The image is then output to a source drive 206 through the control of a timing controller 204, and is eventually output by a LCD panel 207.

FIG. 3 illustrates a conventional LUT. Referring to FIG. 3, generally speaking, each pixel of a frame data has 8 bits. A corresponding value is obtained by looking up a LUT according to a current frame data Gₙ and a previous frame data Gₙ₋₁, and the corresponding value is used for replacing the current frame data, so as to increase the response speed of the LCD. Accordingly, a conventional LUT has 256*256 8-bit corresponding values, which requires about 0.5 Mb SRAM. Besides, if each pixel has red/green/blue (RGB) 3 primary color components and each primary color component is a 8-bit data, then the LUT requires about 1.5 Mb SRAM. As to a LCD with resolution of 1280*768, 22.5 Mb SRAM is required for storing the image data of a previous frame. Therefore how to reduce the sizes of the foregoing two memories is the key for reducing hardware cost.

### SUMMARY OF THE INVENTION

Accordingly, the present invention is directed to a control circuit of a liquid crystal display (LCD) panel, wherein the conventional method of looking up a look up table (LUT) with all data bits of a current frame data and a previous frame data is improved, and the number of bits of the corresponding values in the conventional LUT is reduced, therefore both the storage space used for storing the LUT in a memory and the storage space for storing previous frame data in a frame memory are reduced, accordingly the hardware cost of the LCD panel is also reduced. Moreover, the control circuit selects an appropriate LUT according to the liquid crystal temperature detected by a temperature sensor, a signal processor processes the corresponding values obtained by looking up the selected LUT for obtaining a driving value for replacing the current frame data, so as to increase the response speed of the LCD.

The present invention further provides a LCD panel control method which has the same advantages as the control circuit described above.

The present invention further provides two LCD panel control circuits which have the same advantages as the control circuit and method described above.

The present invention provides a LCD panel control circuit including a frame memory, a LUT module, and a signal processor. The frame memory provides a previous value of a pixel, wherein the previous value includes at least one bit of a previous frame data of the pixel. The LUT module provides a plurality of basic values according to the previous value and a current value of the pixel, wherein the current value includes at least one bit of a current frame data of the pixel. The signal processor produces a driving value according to the basic values and replaces the current frame data with the driving value.

According to the LCD panel control circuit in an embodiment of the present invention, the previous value includes most significant bits (MSB) of the previous frame data and is composed of a plurality of continuous bits of the previous frame data. The current value includes MSBs of the current frame data and is composed of a plurality of continuous bits of the current frame data.

According to the LCD panel control circuit in an embodiment of the present invention, the LUT module includes a LUT unit, wherein the LUT unit stores a LUT and provides a plurality of basic values by looking up the LUT according to the previous value and the current value.

According to the LCD panel control circuit in an embodiment of the present invention, the LUT module includes a plurality of LUT units and a temperature sensor. Each of the LUT units stores a LUT. The temperature sensor appoints one of the LUT units according to the liquid crystal temperature of the pixel, and the appointed LUT unit provides a plurality of basic values by looking up the built-in LUT thereof according to the previous value and the current value.

According to the LCD panel control circuit in an embodiment of the present invention, the LUT module includes a plurality of LUT units and a temperature sensor. Each of the LUT units stores a LUT and provides a plurality of candidate basic values by looking up the LUT according to the previous value and the current value. The temperature sensor selects the candidate basic values of one of the LUT units as the basic values provided by the LUT module according to the liquid crystal temperature of the pixel.

According to the LCD panel control circuit in an embodiment of the present invention, the signal processor performs interpolation by using the basic values to produce the driving value.

According to the LCD panel control circuit in an embodiment of the present invention, the LUT module stores a LUT, and the basic values provided by the LUT module include D[PD][LD] and D[PD][LD+1]. PD is the previous value of the pixel, and LD is the current value of the pixel. D[PD][LD] is a value corresponding to PD and LD in the LUT. D[PD][LD+1] is a value corresponding to PD and LD+1 in the LUT.

According to the LCD panel control circuit in an embodiment of the present invention, the signal processor produces a revised basic value corresponding to each basic value. The previous value of each basic value is PD, and the current value of the basic value is LD. The corresponding revised basic value is equal to the addition of LD*2̂(A−B) and the basic value if LD is greater than PD, and the corresponding revised basic value is equal to the difference between LD*2̂(A−B) and the basic value if LD is smaller than PD. A is a number of bits of the current frame data of the pixel, and B is a number of bits of LD. The signal processor performs interpolation by using the revised basic values to produce the driving value.

According to the LCD panel control circuit in an embodiment of the present invention, the signal processor produces a revised basic value corresponding to each basic value. The revised basic value corresponding to each basic value is equal to a product of the basic value and 2̂P, wherein P is a predetermined positive integer. The signal processor performs interpolation by using the revised basic values to produce the driving value.

The present invention further provides a control method of a LCD panel. The method includes following steps. First, a previous value of a pixel is provided, wherein the previous value includes at least one bit of a previous frame data of the pixel. A plurality of basic values is then provided according to the previous value and a current value of the pixel, wherein the current value includes at least one bit of a current frame data of the pixel. Thereafter a driving value is produced according to the basic values, and the current frame data is replaced with the driving value.

The present invention further provides a display panel control circuit which provides a driving value Fₙ′ according to a current frame data Fₙ and another frame data for driving the corresponding display panel. The control circuit includes at least one LUT unit and a signal processor. Each LUT unit may use a k-bit current value LD as the frame data Fₙ and a m-bit previous value PD as the other frame data, and may provide a corresponding P-bit compensation value with the current value LD and the previous value PD as indices. Each P-bit compensation value is an unsigned value. The signal processor may compare the current value LD and the previous value PD and choose one of increment and decrement according to the comparison result to compensate the frame data Fₙ into the driving value Fₙ′ according to the P-bit compensation value.

The present invention further provides a display panel control circuit which provides a driving value Fₙ′ according to a current frame data Fₙ and another frame data for driving the corresponding display panel. The control circuit includes at least one LUT unit and a signal processor. Each LUT unit may use a k-bit current value LD as the frame data Fₙ and a m-bit previous value PD as the other frame data, and may provide a corresponding P-bit compensation value with the current value LD and the previous value PD as indices, wherein k is smaller than the number of bits of the frame data Fₙ, or m is smaller than the number of bits of the other frame data, or P is smaller than the number of bits of the driving value Fₙ′. The signal processor may compensate the frame data Fₙ into the driving value Fₙ′ according to the P-bit compensation value.

According to the LCD panel control circuit and the method thereof described above, k MSBs of a current frame data and m MSBs of a previous frame data are used for looking up a LUT, wherein k and m are both positive integers, and the number of bits of corresponding values in the LUT is reduced, thus, both the storage space for storing the LUT in a memory and the storage space for storing previous frame data in a frame memory are reduced, accordingly the hardware cost thereof is also reduced. Moreover, since liquid crystal temperature affects the response speed of a LCD, in the foregoing control circuit and control method, one of a plurality of LUTs is looked up according to the liquid crystal temperature to obtain a plurality of basic values, and the basic values obtained by looking up one of the LUTs are processed by a signal processor to obtain a driving value for replacing the current frame data, so as to increase the response speed of the LCD and to allow the LCD to work properly under various temperatures.

In order to make the aforementioned and other objects, features and advantages of the present invention comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a waveform of a driving voltage in a conventional liquid crystal display (LCD) which charges a capacitor in a pixel to desired brightness.

FIG. 1B is a waveform of a driving voltage in a conventional liquid crystal display (LCD) which charges a capacitor in a pixel to desired brightness.

FIG. 2 is a schematic block diagram illustrating the response speed of a LCD being increased by an accelerating voltage in a conventional LCD.

FIG. 3 illustrates a conventional look up table (LUT).

FIG. 4 is a schematic block diagram of a control circuit in a LCD panel according to an exemplary embodiment of the present invention.

FIGS. 5A and 5B are waveforms of driving voltages for image enhancement according to an exemplary embodiment of the present invention.

FIG. 6 illustrates a LUT according to an exemplary embodiment of the present invention.

FIG. 7 illustrates a LUT according to an exemplary embodiment of the present invention.

FIG. 8 illustrates a LUT according to an exemplary embodiment of the present invention.

FIG. 9 is an operation flowchart of a signal processor according to an exemplary embodiment of the present invention.

FIG. 10 illustrates a LUT according to an exemplary embodiment of the present invention.

FIG. 11 is a schematic diagram of a control circuit of a LCD panel according to an exemplary embodiment of the present invention.

FIG. 12 is a schematic diagram of a control circuit of a LCD panel according to an exemplary embodiment of the present invention.

FIG. 13 is a flowchart illustrating a control method of a LCD panel according to an exemplary embodiment of the present invention.

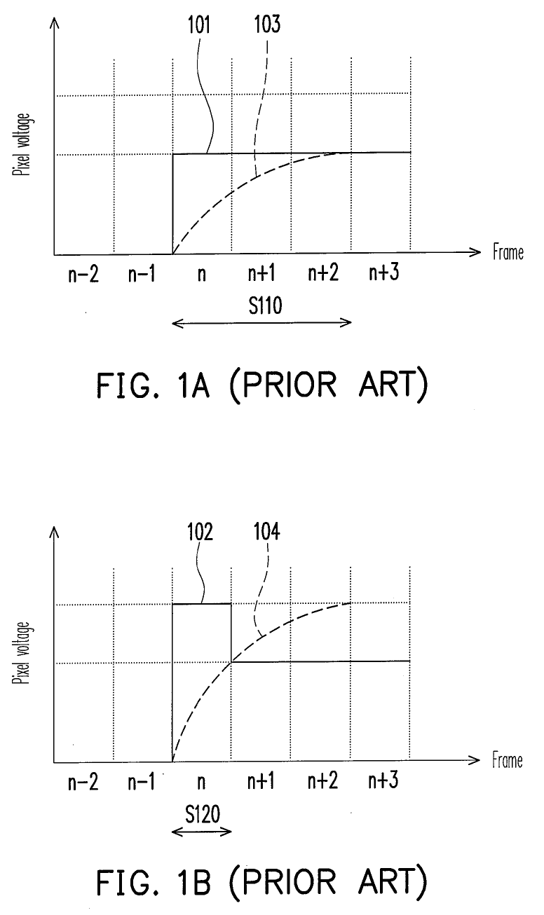

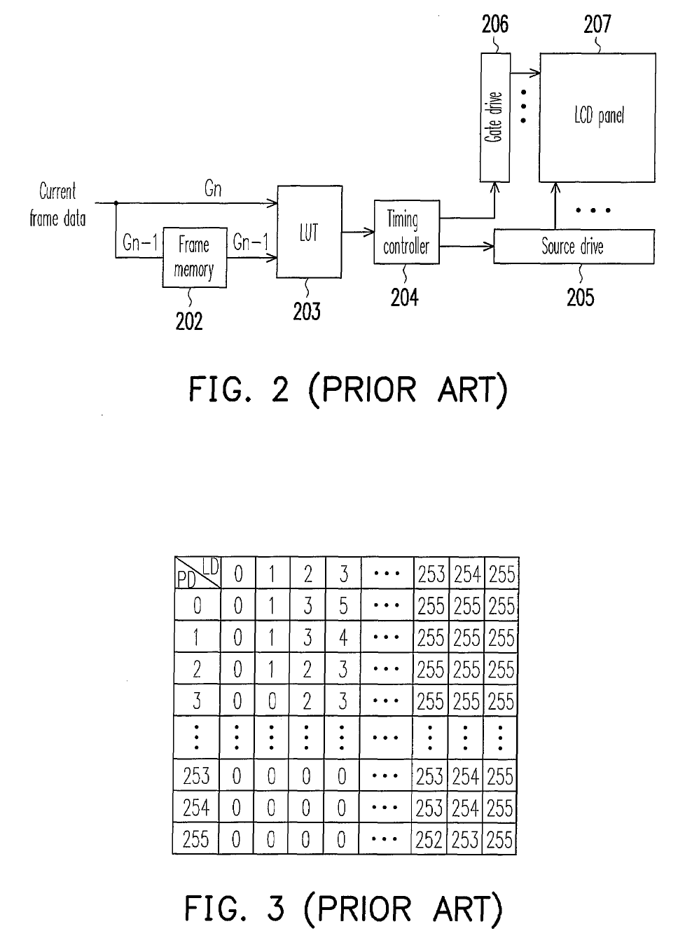

### DESCRIPTION OF EMBODIMENTS

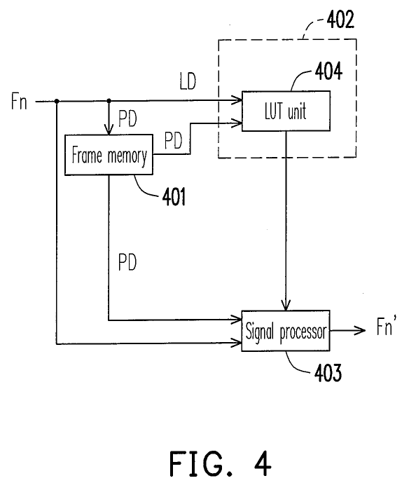

Before describing the present embodiment, first it is assumed that a frame data has 8 bits (i.e. the related data of each pixel is an 8-bit data, for example, the red/green/blue components of each pixel are respectively an 8-bit data, or the brightness data of each pixel is an 8-bit data); however, the present embodiment is not limited to foregoing assumption. FIG. 4 is a schematic block diagram of a control circuit in a LCD panel according to an exemplary embodiment of the present invention. Referring to FIG. 4, the liquid crystal display (LCD) panel control circuit includes a frame memory 401, a look-up table (LUT) module 402, and a signal processor 403. The LUT module 402 further includes a LUT unit 404. The frame memory 401 provides a previous value PD of a pixel. In the present embodiment, the previous value PD is m most significant bits (MSB) of a previous frame data of the pixel, wherein m is a positive integer. The LUT unit 404 in the LUT module 402 stores a LUT (described in detail below). A plurality of corresponding values are obtained by looking up the LUT according to the previous value PD and a current value LD of the pixel, and these values are provided to the signal processor 403 to be calculated as basic values, so as to produce a driving value Fₙ′. The driving value Fₙ′ is used for replacing a current frame data Fₙ and is outputted to a timing controller (not shown) to increase the response speed of the LCD. In the present embodiment, the current value LD is k MSBs of the current frame data of the pixel, wherein k is also a positive integer. Accordingly, the LUT has 2^{k}×2^{m} 8-bit corresponding values.

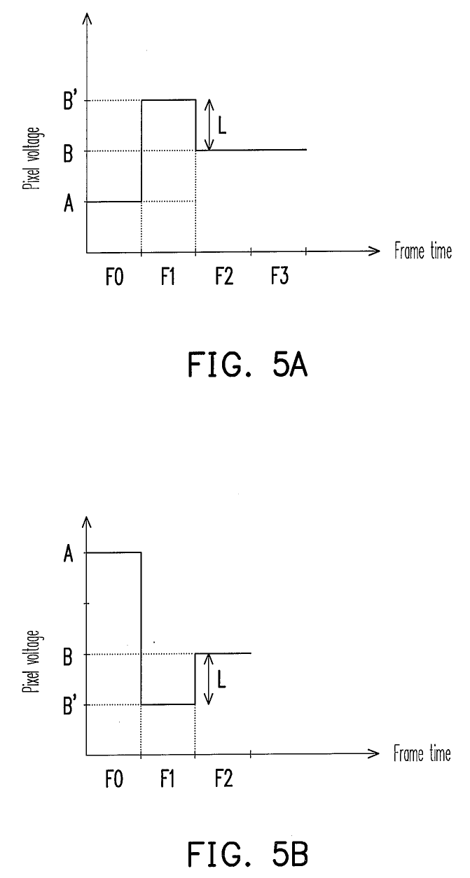

FIGS. 5A and 5B shows waveforms of driving voltages for image enhancement according to an exemplary embodiment of the present invention. In FIG. 5A, the pixel voltage should be increased from A to B at frame time F1, and since voltage at B is higher than voltage at A, the response speed of the LCD could be increased if the pixel voltage B is appropriately increased to the accelerating voltage B′. However, in the present embodiment, to obtain the suitable value B′ according to the relationship between A and B, a value L (L=B′−B) is recorded as a corresponding value in the LUT, and L is a positive value. Contrarily, in FIG. 5B, the original pixel voltage should be decreased from A to B at frame time F1, and since voltage at B is lower than voltage at A, the response speed of the LCD could be increased if the pixel voltage B is appropriately decreased to the accelerating voltage B′. However, in the present embodiment, to obtain the suitable value B′ according to the relationship between A and B, L=B−B′ is filled as a corresponding value in the LUT. It should be noted here that L is also a positive value. As described above, in the present embodiment, the corresponding value in the LUT is always positive regardless whether the pixel voltage is increased from A to a higher level B or decreased to a lower level B. Thus, a bit for determining the sign of the corresponding value can be skipped, namely, a sign bit can be skipped. In other words, in the present invention, an unsigned value is used for recording value L, and value L can be considered as a compensation value of a driving voltage of a pixel.

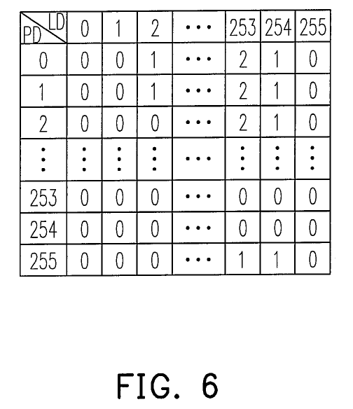

FIG. 6 illustrates a LUT according to an exemplary embodiment of the present invention. The previous value PD is 8 bits of a previous fame data of a pixel (i.e. m=8), thus, the value of PD in the LUT is between 0 and 255. The current value LD is 8 bits of a current frame data of the pixel (i.e. k=8), thus, the value of LD in the LUT is between 0 and 255. A corresponding value D[PD][LD] is obtained by looking up the LUT according to the previous value PD and the current value LD. The corresponding value D[PD][LD] is a positive value (as described above), namely, a bit for determining the sign of the corresponding value D[PD][LD] is skipped, so that the LUT has 2⁸×2⁸ 7-bit corresponding values. Accordingly, the storage space in the memory for storing the LUT is reduced.

Next, referring to FIG. 4 and FIG. 6, assuming the previous value PD of the pixel is 255 and the current value LD thereof is 253, the corresponding value D[PD][LD] obtained from the LUT is 1. Since the current value LD of the pixel is smaller than the previous value PD thereof (comparing the same number of bits), the signal processor 403 subtracts the corresponding value (D[PD][LD]=1) from the current value (LD=253) and outputs the driving value (Fₙ′=252) for replacing the current frame data Fₙ, so as to increase the response speed of the LCD. Assuming the previous value PD of the pixel is 1 and the current value LD thereof is 2, the corresponding value D[PD][LD] obtained from the LUT is 1. Since the current value LD of the pixel is greater than the previous value PD thereof (comparing the same number of bits), the signal processor 403 adds the corresponding value (D[PD][LD]=1) to the current value thereof (LD=2) and outputs the driving value (Fₙ′=3) for replacing the current frame data Fₙ, so as to increase the response speed of the LCD. Besides, if the current frame data Fₙ of the pixel is 0 or 255, the signal processor 403 then directly outputs the current frame data Fₙ as the driving value Fₙ′.

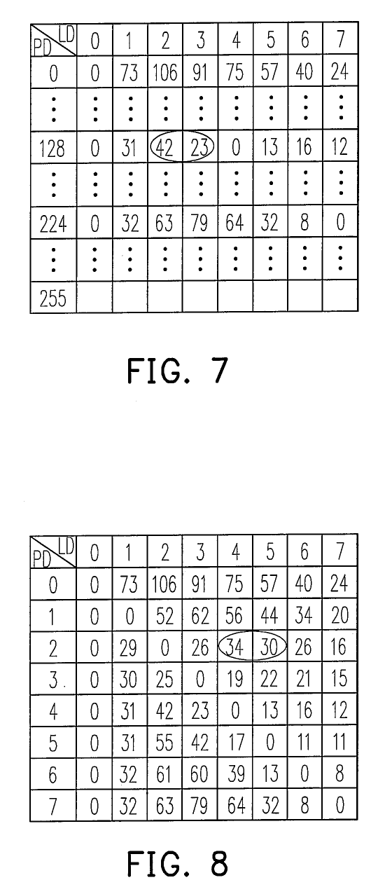

FIG. 7 illustrates a LUT according to an exemplary embodiment of the present invention, wherein the previous value is the 8-bit previous frame data of the pixel (i.e. m=8), thus, the value of PD in the LUT is between 0 and 255. In the present embodiment, to reduce the storage space used for storing the LUT in the memory, only 3 MSBs of the current frame data (i.e. k=3) may be obtained as the current value LD, therefore the value of LD in the LUT is between 0 and 7. A corresponding value D[PD][LD] is obtained by looking up the LUT according to the previous value PD and the current value LD. As in FIG. 6, each corresponding value D[PD][LD] in FIG. 7 may also be a positive value, and similarly, one bit for determining the sign of the corresponding value D[PD][LD] can be skipped; however, the present embodiment is not limited thereto. Accordingly, the LUT has 2³×2⁸ 7-bit corresponding values and the storage space used for storing the LUT in the memory is further reduced.

FIG. 8 illustrates a LUT according to an exemplary embodiment of the present invention. Referring to FIG. 4 and FIG. 8, to further reduce the storage space used for storing the previous frame data in the frame memory 401 and the storage space used for storing the LUT in the memory, the previous value PD may be 3 MSBs of the previous frame data (i.e. m=3), therefore the value of PD in the LUT is between 0 and 7. Similarly, to reduce the storage space in the memory used for storing the LUT, the current value LD is 3 MSBs of the current frame data (i.e. k=3), therefore the value of LD in the LUT is between 0 and 7. A corresponding value D[PD][LD] is obtained by looking up the LUT according to the previous value PD and the current value LD. Here it is assumed that the corresponding value D [PD][LD] is a positive value, therefore a bit for determining the sign of the corresponding value D[PD][LD] is skipped; however, the present embodiment is not limited to foregoing assumption. As described above, the LUT in FIG. 8 has only 2³×2³ 7-bit corresponding values, so that both the storage space in the frame memory 401 used for storing previous frame data and the storage space in the memory used for storing the LUT are reduced.

Next, referring to FIG. 4 and FIG. 8, assuming the previous value PD of the pixel is 2 and the current value LD thereof is 4, a corresponding value D[PD][LD] obtained from the LUT is 34. The current value LD is 3 MSBs of the current frame data Fₙ, which means the current frame data Fₙ is between the values for restoring the current value LD and LD+1 to have the same number of bits as the current frame data Fₙ does (8 bits), namely, the current frame data Fₙ is between LD*2̂(8−3) and (LD+1)*2̂(8−3). Since the LUT in FIG. 8 is not directly mapped to the corresponding compensation values of the current frame data Fₙ, the corresponding compensation values of the current frame data Fₙ have to be calculated through interpolation. Accordingly, the signal processor 403 has to restore the current values LD and LD+1 to have the same number of bits as the current frame data Fₙ does (8 bits), which are respectively 4*2̂(8−3)=128 and 5*2̂(8−3)=160, and the signal processor 403 performs interpolation by using the corresponding values D[PD][LD]=34 and D[PD][LD+1]=30 obtained from the LUT. Since both the current values LD and LD+1 are greater than the previous value PD (comparing the same number of bits), the signal processor 403 adds the basic values to the restored current values to obtain revised basic values, which are respectively 128+34=162 and 160+30=190. Finally, the signal processor 403 performs interpolation by using these revised basic values to produce a more accurate driving value Fₙ′ for replacing the current frame data Fₙ, so as to increase the response speed of the LCD. Besides, if the current frame data Fₙ of the pixel is 0 or 255, the signal processor 403 then directly outputs the current frame data Fₙ as the driving value Fₙ′.

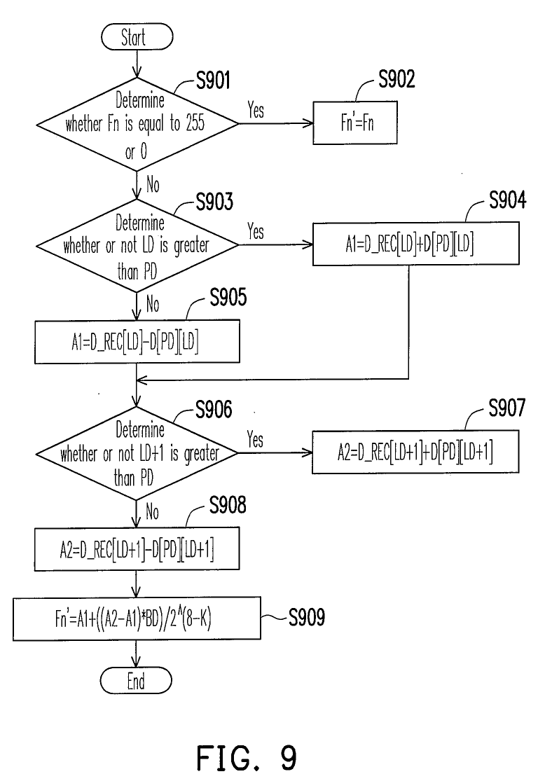

The operation of the signal processor 403 will be described in detail along with the LUT in FIG. 8. FIG. 9 is an operation flowchart of the signal processor in the present embodiment. Referring to FIG. 4 and FIG. 9, first, the signal processor 403 determines whether or not the current frame data Fₙ is equal to 255 or equal to 0 in step S901; if Fₙ=255 or Fₙ=0, the signal processor 403 outputs data Fₙ′=Fₙ in step S902; and if Fₙ≠255 and Fₙ≠0, the procedure proceeds to step S903. In step S903, whether or not LD is greater than PD (comparing the same number of bits, the value having insufficient number of bits is restored by adding 0 to lower bits) is determined; if LD>PD, a revised basic value A1=D_REC[LD]+D[PD][LD] is obtained in step S904, wherein D_REC[LD]=LD*2̂(8−k) is to restore the current value LD to the same number of bits of the current frame data Fₙ (8 bits); and if LD<PD, a revised basic value A1=D_REC[LD]−D[PD][LD] is obtained in step S905. Next, in step S906, whether or not LD+1 is greater than PD (comparing the same number of bits, the value having insufficient number of bits is restored by adding 0 to lower bits) is determined; if LD+1>PD, a revised basic value A2=D_REC[LD+1]+D[PD][LD+1] is obtained in step S907; and if LD+1<PD, a revised basic value A2=D_REC[LD+1]−D[PD][LD+1] is obtained in step S908. In step S909, the signal processor 403 performs interpolation by using the revised basic values A1 and A2 to produce a more accurate driving value for replacing the current frame data. The interpolation algorithm adopted in the present embodiment is Fₙ′=A1+((A2−A1)*BD/2̂(8−k)), wherein BD is (8−k) least significant bits (LSB) of the current frame data Fₙ; however, the present embodiment is not limited thereto.

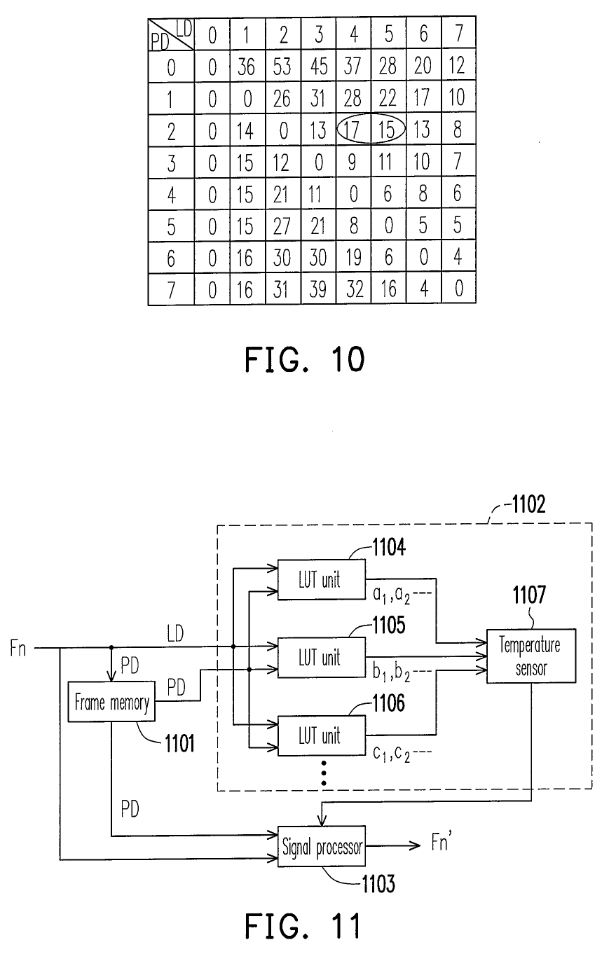

FIG. 10 illustrates a LUT according to an exemplary embodiment of the present invention. Referring to FIG. 4 and FIG. 10, to reduce the storage space in the frame memory 401 used for storing previous frame data and the storage space in the memory for storing the LUT, the previous value is 3 bits of the previous frame data of the pixel (i.e. m=3), accordingly the value of PD in the LUT is between 0 and 7. The current value LD is 3 MSBs of the current frame data of the pixel (i.e. k=3), accordingly the value of LD in the LUT is between 0 and 7. To further reduce the storage space used for storing the LUT in the memory, the corresponding values in the LUT may be reduced to P MSBs of the original corresponding values. For example, in the present embodiment, the corresponding values in the LUT in FIG. 10 are filled into the 6 MSBs (i.e. P=6) of the corresponding values in the LUT in FIG. 8, therefore, the LUT has 2³×2³ 6-bit corresponding values so that the storage space used for storing the LUT in the memory is further reduced.

Next, referring to FIG. 4 and FIG. 10, assuming the previous value PD of the pixel is 2 and the current value LD thereof is 4, the corresponding value D[PD][LD] obtained by looking up the LUT is 17. The current value LD is 3 MSBs of the current frame data Fₙ, which means the current frame data Fₙ is between values for restoring the current value LD and LD+1 to have the same number of bits as the current frame data Fₙ does (8 bits). Accordingly, the signal processor 403 restores the current value LD and LD+1 to have the same number of bits as the current frame data Fₙ does (8 bits), and the signal processor 403 restores the corresponding values D[PD][LD]=17 and D[PD][LD+1]=15 obtained from the LUT to the original number of bits of corresponding values (7 bits). Since the current values LD and LD+1 are both greater than the previous value PD, revised basic values are obtained by adding the restored current values to the restored basic values, which are 4*2̂(8−3)+17*2(7−6)=162 and 5*2̂(8−3)+15*2̂(7−6)=190. Finally, the signal processor 403 performs interpolation by using these revised basic values to produce the driving value Fₙ′ for replacing the current frame data Fₙ, so as to increase the response speed of the LCD.

On the other hand, similar as in steps S903 to S908 in FIG. 9, if the current value LD or LD+1 is smaller than the previous value PD, the revised basic values are obtained by subtracting the restored basic values from the restored current values. Besides, if the current frame data Fₙ of the pixel is 0 or 255, the signal processor 403 then directly outputs the current frame data Fₙ as the driving value Fₙ′.

FIG. 11 is a schematic diagram of a control circuit of a LCD panel according to an exemplary embodiment of the present invention, wherein the effect of temperature on the response speed of the LCD is considered, and the higher the temperature is, the faster the response speed of the LCD is. Accordingly, the pixel voltage driving performance changes along with the temperature. The embodiment in FIG. 11 switches between LUTs according to the temperature. Referring to FIG. 11, in the present embodiment, the LCD panel control circuit includes a frame memory 1101, a LUT module 1102, and a signal processor 1103. The LUT module 1102 further includes LUT units 1104˜1106 (here only 3 LUT units are shown demonstratively) and a temperature sensor 1107. Referring to FIG. 4 and FIG. 11, the control circuit in the present embodiment is similar to that illustrated in FIG. 4, and the only difference is that the LUT units 1104˜1106 in the LUT module 1102 respectively stores a LUT. The corresponding values of each LUT are obtained by looking up each LUT according to the previous value PD and current value LD of the pixel, and a plurality of corresponding values provided by each LUT are provided as candidate basic values a₁, a₂ . . . , b₁, b₂ . . . and c₁, c₂ . . . . The temperature sensor 1107 selects the candidate basic values of one of the LUTs, such as a₁, a₂ . . . of the LUT unit 1104, according to the liquid crystal temperature and then outputs the selected candidate basic values to the signal processor 1103. The signal processor 1103 calculates the candidate basic values to produce the driving value Fₙ′ for replacing the current frame data Fₙ. As described above, the LCD panel can work properly under various temperatures.

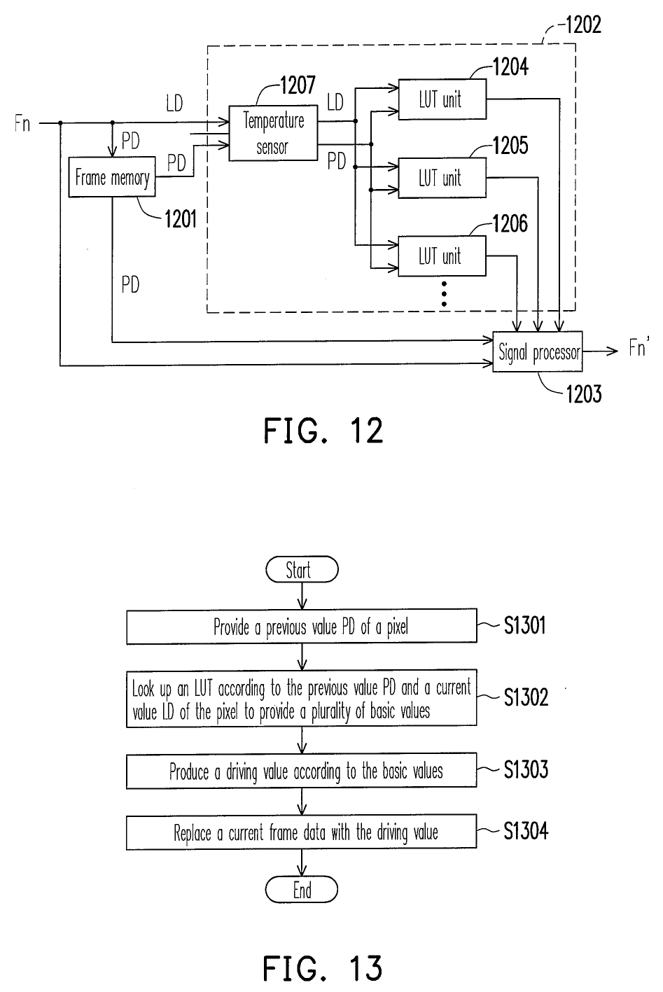

The temperature sensor in FIG. 11 may be moved before the LUT units, as shown in FIG. 12. FIG. 12 is a schematic diagram of a control circuit of a LCD panel according to an exemplary embodiment of the present invention. In the present embodiment, the LCD panel control circuit includes a frame memory 1201, a LUT module 1202, and a signal processor 1203. The LUT module 1202 further includes LUT units 1204˜1206 (here only 3 LUT units are illustrated demonstratively) and a temperature sensor 1207. Referring to FIG. 4 and FIG. 12, the control circuit in the present embodiment is similar to that illustrated in FIG. 4, and the only difference is that the LUT units 1204˜1206 in the LUT module 1202 respectively stores a LUT. The temperature sensor 1207 selects one of the LUTs according to the liquid crystal temperature, and provides the corresponding values obtained by looking up the LUT to the signal processor 1203 as basic values. The signal processor 1203 performs interpolation by using the basic values to produce the driving value Fₙ′ for replacing the current frame gate Fₙ.

FIG. 13 is a flowchart illustrating a control method of a LCD panel according to an exemplary embodiment of the present invention. First, the frame memory provides a previous value PD of a pixel in step S1301, and the frame memory then provides a plurality of basic values by looking up the LUT according to the previous value PD and a current value LD of the pixel in step S1302. After that the signal processor performs a calculation by using the basic values to obtain a driving value in step S1303 and replaces a current frame data of the pixel with the driving value in step S1304, so as to increase the response speed of the LCD. This control method described here shows the operation flow of the LCD panel control circuit in foregoing embodiment. Various variations and details of the control method have been described in foregoing embodiment, therefore which will not be described herein.

In summary, according to the embodiments described above, the memory for storing the LUT is static random access memory (SRAM) such as to look up the corresponding values in the LUT quickly. Generally speaking, the frame memory for storing previous frame data is dynamic random access memory (DRAM), but which is not limited herein. According to an embodiment of the present invention, the corresponding values in the LUT are always positive values, namely, it is not necessary to determine the sign bits of the corresponding values, therefore the storage space in the memory for storing the LUT can be reduced. In addition, the LUT is looked up according to a previous value, which is m MSBs of the previous frame data, and a current value, which is k MSBs of the current frame data, wherein k and m are both positive integers, so that both the storage space for storing previous frame data and the storage space for storing the LUT in the memory can be reduced. Moreover, only P MSBs of the corresponding values are filled in the LUT and these values in the LUT can be restored back to original number of bits by the signal processor, therefore the storage space for storing the LUT in the memory can be further reduced. Furthermore, since liquid crystal temperature affects the response speed of the LCD and the storage space for storing each LUT can be reduced in the present invention, a plurality of LUTs can be provided with limited storage space and one of the LUTs is selected according to the liquid crystal temperature, so that the LCD panel can work properly under various temperatures.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A control circuit of a liquid crystal display (LCD) panel, the control circuit comprising:
a frame memory, providing a previous value of a pixel, wherein the previous value comprises at least one bit of a previous frame data of the pixel;
a look-up table (LUT) module, providing a plurality of basic values according to the previous value and a current value of the pixel, wherein the current value comprises at least one bit of a current frame data of the pixel; and
a signal processor, producing a driving value according to the basic values, replacing the current frame data with the driving value.

2. The control circuit as claimed in claim 1, wherein the previous value comprises a most signification bit (MSB) of the previous frame data and consists of a plurality of continuous bits of the previous frame data; the current value comprises an MSB of the current frame data and consists of a plurality of continuous bits of the current frame data.

3. The control circuit as claimed in claim 1, wherein the LUT module comprises:
a LUT unit, storing a LUT, looking up the LUT according to the previous value and the current value to provide the basic values.

4. The control circuit as claimed in claim 1, wherein the LUT module comprises:
a plurality of LUT units, each of the LUT units storing a LUT; and
a temperature sensor, appointing one of the LUT units according to a liquid crystal temperature of the pixel, the appointed LUT unit looking up the built-in LUT according to the previous value and the current value to provide the basic values.

5. The control circuit as claimed in claim 1, wherein the LUT module comprises:
a plurality of LUT units, each of the LUT units storing a LUT and looking up the LUT according to the previous value and the current value to provide a plurality of candidate basic values; and
a temperature sensor, selecting the candidate basic values of one of the LUT units as the basic values provided by the LUT module according to the liquid crystal temperature of the pixel.

6. The control circuit as claimed in claim 1, wherein the signal processor performs interpolation by using the basic values to produce the driving value.

7. The control circuit as claimed in claim 6, wherein the LUT module stores a LUT, and the basic values comprise D[PD][LD] and D[PD][LD+1], wherein PD is the previous value of the pixel, LD is the current value of the pixel, D[PD][LD] is a value corresponding to PD and LD in the LUT, and D[PD][LD+1] is a value corresponding to PD and LD+1 in the LUT.

8. The control circuit as claimed in claim 6, wherein the signal processor produces a revised basic value corresponding to each of the basic values, the previous value of each basic value is PD, the current value of the basic value is LD, the corresponding revised basic value is equal to the addition of LD*2̂(A−B) and the basic value if LD is greater than PD, the corresponding revised basic value is equal to the difference between the LD*2̂(A−B) and the basic value if LD is smaller than PD, wherein A is a number of bits of the current frame data of the pixel, B is a number of bits of LD, and the signal processor performs interpolation by using the revised basic values to produce the driving value.

9. The control circuit as claimed in claim 6, wherein the signal processor produces a revised basic value corresponding to each of the basic values, the revised basic value corresponding to each of the basic values is equal to a product of the basic value and 2̂P, wherein P is a predetermined positive integer, and the signal processor performs interpolation by using the revised basic values to produce the driving value.

10. A control method of a LCD panel, the control method comprising:
providing a previous value of a pixel, wherein the previous value comprises at least one bit of a previous frame data of the pixel;
providing a plurality of basic values according to the previous value and a current value of the pixel, wherein the current value comprises at least one bit of a current frame data of the pixel;
producing a driving value according to the basic values; and
replacing the current frame data with the driving value.

11. The control method as claimed in claim 10, wherein the previous value comprises an MSB of the previous frame data and consists of a plurality of continuous bits of the previous frame data; the current value comprises an MSB of the current frame data and consists of a plurality of continuous bits of the current frame data.

12. The control method as claimed in claim 10, wherein the step of providing the basic values comprises:
providing a LUT; and
looking up the LUT according to the previous value and the current value to provide the basic values.

13. The control method as claimed in claim 10, wherein the step of providing the basic values comprises:
providing a plurality of LUTs;
appointing one of the LUTs according to a liquid crystal temperature of the pixel; and
looking up the appointed LUT according to the previous value and the current value to provide the basic values.

14. The control method as claimed in claim 10, wherein the step of providing the basic values comprises:
providing a plurality of LUTs;
looking up each of the LUTs according to the previous value and the current value to provide a plurality of candidate basic values from each of the LUTs; and
selecting the candidate basic values of one of the LUTs as the basic values according to the liquid crystal temperature of the pixel.

15. The control method as claimed in claim 10, wherein the driving value is produced by performing interpolation by using the basic values.

16. The control method as claimed in claim 15 further comprising:
providing a LUT; wherein
the basic values comprise D [PD][LD] and D[PD][LD+1];
PD being the previous value of the pixel;
LD being the current value of the pixel;
D[PD][LD] being a value corresponding to PD and LD in the LUT;
D[PD][LD+1] being a value corresponding to PD and LD+1 in the LUT.

17. The control method as claimed in claim 15, wherein the step of producing the driving value comprises:
producing a revised basic value corresponding to each of the basic values; and
performing interpolation by using the revised basic values to produce the driving value;
wherein the previous value of each of the basic values is PD, the current value of the basic value is LD, the corresponding revised basic value is equal to the addition of LD*2̂(A−B) and the basic value if LD is greater than PD, and the corresponding revised basic value is equal to the difference between LD*2̂(A−B) and the basic value if LD is smaller than PD, wherein A is a number of bits of the current frame data of the pixel, and B is a number of bits of LD.

18. The control method as claimed in claim 15, wherein the step of producing the driving value comprises:
producing a revised basic value corresponding to each of the basic values; and
performing interpolation by using the revised basic values to produce the driving value;
wherein the revised basic value corresponding to each of the basic values is equal to a product of the basic value and 2̂P, and P is a predetermined positive integer.

19. A control circuit of a display panel, suitable for providing a driving value Fₙ′ according to a current frame data Fₙ and another frame data to drive the corresponding display panel, the control circuit comprising:
at least one LUT unit, each of the LUT units using a k-bit current value LD as the frame data Fₙ and a m-bit previous value PD as said another frame data, each of the LUT units also providing a corresponding P-bit compensation value with the current value LD and the previous value PD as indices, wherein each said P-bit compensation value is an unsigned value; and
a signal processor, comparing the current value LD and the previous value PD and compensating the frame data Fₙ into the driving value Fₙ′ according to the P-bit compensation value by selecting one of increment and decrement according to the comparison result.

20. A control circuit of a display panel, providing a driving value Fₙ′ according to a current frame data Fₙ and another frame data for driving the corresponding display panel, the control circuit comprising:
at least one LUT unit, each of the LUT units using a k-bit current value LD as the frame data Fₙ and a m-bit previous value PD as another frame data, each of the LUT units also providing a corresponding P-bit compensation value with the current value LD and the previous value PD as indices, wherein k is smaller than a number of bits of the frame data Fₙ or m is smaller than a number of bits of said another frame data, or P is smaller than a number of bits of the driving value Fₙ′; and
a signal processor, compensating the frame data Fₙ into the driving value Fₙ′ according to the P-bit compensation value.
